(19) United States
(12) Patent Application Publication
(10) Pub. No.: US 2020/0380927 A1
(43) Pub. Date: Dec. 3, 2020

(54) MULTIPLEXING LIQUID CRYSTAL DISPLAY DRIVING CIRCUIT

(71) Applicant: Wuhan China Star Optoelectronics Technology Co., Ltd., Wuhan, Hubei (CN)

(72) Inventor: Fei AI, Wuhan, Hubei (CN)

(21) Appl. No.: 16/613,423

(22) PCT Filed: Oct. 18, 2019
(86) PCT No.: PCT/CN2019/111975

§ 371 Date: Nov. 14, 2019

(30) Foreign Application Priority Data
May 28, 2019 (CN) 201910450866.5

(51) Int. Cl. G09G 3/36

(52) U.S. Cl. CPC G09G 3/3614; G09G 2310/06

(57) ABSTRACT

The present disclosure proposes a multiplex LCD driving circuit. By setting a new circuit structure, adjacent display pixels of the same color are opposite in polarity in the same row of subpixels. In this way, half of the data lines are applied with positive polarity voltage and half of the data line are applied with negative polarity voltage. Capacitance couplings between the data lines and the common electrodes are balanced off each other, which resolves the display picture abnormality caused by the coupling capacitance between the data line and the common electrode in the LTPS-LCD product.

### BACKGROUND

### 1. Field of the Disclosure

The present disclosure relates to techniques of liquid crystal display (LCD), and more particularly, to a multiplexing LCD driving circuit.

### 2. Description of the Related Art

Owing to high-resolution, lightweight, compact, and widely applied features, a liquid-crystal display (LCD) is widely applied in a variety of consumer electronics such as cellphones, televisions (TVs), personal digital assistants (PDAs), digital cameras, notebook computers, desktop computers, etc, so the LCD has becomes the mainstream product on the market. In particular, a low temperature poly-silicon (LTPS) LCD can achieve higher switching current ratio of a thin film transistor (TFT) owing to the higher carrier mobility of the LTPS LCD. Each pixel transistor can be further miniaturized under the condition of satisfying the requirement for the charging current. Therefore, the light transmission area of the transparent area of each pixel is increased. The panel opening ratio is improved. The panel brightness and high resolution is improved. The panel power consumption is reduced. Therefore, a better visual experience is brought to the user.

An LCD is a passively driven display device such as a DEMUX driver of the related art. The light flux modulation is realized by adjusting the alignment state of liquid crystal molecules which are mainly controlled by an electric field. A defined active drive matrix (Array) matches the deflection of the liquid crystals in each of the pixel areas. As an LTPS active matrix features a smaller size, the consequent advances in lithography have led to an exponential increase in equipment costs. In order to reduce the production cost and the cycle of the LTPS substrate, a provincial flattening layer (PLN) process technology is proposed to manufacture an LTPS array substrate with In-Cell touch function. The In-Cell refers to a method of embedding a touch panel function into a liquid crystal pixel. However, after the flattening layer is removed, the coupling capacitance between a source/drain and an indium tin oxide (ITO) common electrode is relatively increased, causing an abnormality in the display screen such as a picture string or a heavy load.

A driving design of a demultiplexer DEMUX of the related art is illustrated in FIG. 1. The polarity of each subpixel display is illustrated in FIG. 2. The driving method is adopted when displaying heavy loads and other similar pictures (the pixel rows and columns are arranged at different intervals, and the polarity of all subpixels is inverted every time one frame is scanned), as illustrated in FIG. 3. Since the same color subpixels of the same row have the same polarity when displayed, when the demultiplexer turns on charging the subpixels. All data lines corresponding to the same color subpixel of the same row produce a coupling in the same direction to the common electrode. Such coupling can cause the common electrode potential to be out of alignment, resulting in display abnormality.

Therefore, it is urgent to propose a new driving circuit for a liquid crystal display (LCD) panel to deal with the problem that a data line generates a coupling capacitance to a common electrode.

### SUMMARY

An object of the present disclosure is to propose a multiplexed liquid crystal display (LCD) driving circuit. When the display screen is overloaded, the same row of the same color display pixels adjacent to the opposite polarity at the time of display. Data lines of positive and negative polarity offsets coupling between common electrodes so the problem of the related art that misalignment of a common voltage level and abnormality of a display panel are resolved.

According to an embodiment of the present disclosure, a multiplexing liquid crystal display (LCD) driving circuit includes a plurality of driving units. Each of the plurality of driving units comprises a plurality of multiplexing modules, a plurality of vertical data lines which are in parallel and arranged sequentially, two or more scanning lines which are in parallel and thus arranged in parallel, and subpixels arranged in an area surrounded by the plurality of data lines and the plurality of scanning lines.

Each of the subpixels is correspondingly connected to the scanning line and the data line, respectively; the subpixel comprises the subpixels in a plurality rows and a plurality of column subpixels and the subpixels in a plurality columns.

Each of the subpixel in the row comprises a plurality of red subpixels, a plurality of green subpixels, and a plurality of blue subpixels; the red subpixel, the green subpixel, and the blue subpixel forming a plurality of display pixels; one of the red subpixel, one of the green subpixel, and one of the blue subpixel forming each of a plurality of display pixels.

The electrical property of a display pixel being opposite to the electrical property of a display pixel adjacent the former display pixel of the same color on display in the subpixels in the same row.

Optionally, the driving unit comprises 12 data lines and four multiplexing modules. Each of the multiplexing modules comprises three thin film transistors (TFT). A gate of each of the TFTs is electrically connected to a first branch controlling signal, a second branch controlling signal, and a third branch controlling signal. A source of each of the TFTs is electrically connected to the same data signal; a drain of each of the TFTs is electrically connected to the data line.

Optionally, the multiplexing module comprises a first multiplexing module, a second multiplexing module, a third multiplexing module, and a fourth multiplexing module. The first multiplexing module comprises: a first TFT, a second TFT, and a TFT.

A gate of the first TFT is electrically connected to the first branch controlling signal. A source of the first TFT is electrically connected to the first data signal. A drain of the first TFT is electrically connected to the first data line. A gate of the second TFT is electrically connected to the second branch controlling signal. A source of the second TFT is electrically connected to the first data signal. A drain of the second TFT is electrically connected to the eighth data line. a gate of the third TFT is electrically connected to the third branch controlling signal. A source of the third TFT is electrically connected to the first data signal. A drain of the third TFT is electrically connected to the third data line. The second multiplexing module comprises a fourth TFT, a fifth TFT and a sixth TFT. A gate of the fourth TFT is electrically connected to the first branch controlling signal. A source of the fourth TFT is electrically connected to the second data signal. A drain of the fourth TFT is electrically connected to the second data line. A gate of the fifth TFT is electrically connected to the second branch controlling signal. A source of the fifth TFT is electrically connected to the second data signal. A drain of the fifth TFT is electrically connected to the third data line. A gate of the sixth TFT is electrically connected to the third branch controlling signal. A source of the sixth TFT is electrically connected to the second data signal. A drain of the sixth TFT is electrically connected to the fifth data line. The third multiplexing module comprises a seventh TFT, an eighth TFT and a ninth TFT. A gate of the seventh TFT is electrically connected to the first branch controlling signal. A source of the seventh TFT is electrically connected to the third data signal (Data3); a drain of the seventh TFT is electrically connected to the seventh data line. A gate of the eighth TFT is electrically connected to the second branch controlling signal. A source of the eighth TFT is electrically connected to the third data signal. A drain of the eighth TFT is electrically connected to the ninth data line. A gate of the ninth TFT is electrically connected to the third branch controlling signal. A source of the ninth TFT is electrically connected to the third data signal. A drain of the ninth TFT is electrically connected to the twelfth data line. The fourth multiplexing module comprises a tenth TFT, an eleventh TFT, and a twelfth TFT. A gate of the tenth TFT is electrically connected to the first branch controlling signal. A source of the tenth TFT is electrically connected to the fourth data signal. A drain of the tenth TFT is electrically connected to the eighth data line. A gate of the eleventh TFT is electrically connected to the second branch controlling signal. A source of the eleventh TFT is electrically connected to the fourth data signal. A drain of the eleventh TFT is electrically connected to the tenth data line. A gate of the twelfth TFT is electrically connected to the third branch controlling signal. A source of the twelfth TFT is electrically connected to the fourth data signal. A drain of the twelfth TFT is electrically connected to the eleventh data line.

Optionally, the first multiplexing module, the second multiplexing module, the third multiplexing module, and the fourth multiplexing module are all N-type TFTs or P-type TFTs.

Optionally, the electrical property of the first data signal is the same as the electrical property of the third data signal. The electrical property of the second data signal is the same as the electrical property of the fourth data signal. The electrical property of the first data signal is different from the electrical property of the second data signal.

Optionally, the electrical properties of the subpixels in the same column are the same. The electrical property of the display pixel in the same column is the same as the electrical property of a neighboring display pixels of the same color in the same column.

Optionally, the subpixels, the red subpixel, the green subpixel, and the blue subpixel in each row are alternately arranged.

Optionally, each subpixel includes a TFT and a pixel electrode. A gate of the TFT is electrically connected to a scanning line corresponding to the subpixel in the row. A source of the TFT is electrically connected to a data line corresponding to the subpixel in the column. A drain of the TFT is electrically connected to the pixel electrode.

Optionally, the subpixel in the column comprises 12 columns of subpixels. The polarity of the subpixels in the first to third columns are positive, negative, and positive. The polarity of the subpixels in the fourth to sixth columns are positive, negative, and positive. The polarity of the subpixels in the seventh to ninth columns are negative, positive, and negative. The polarity of the subpixels in the tenth to twelfth columns are negative, positive, and negative.

Optionally, the TFT of the subpixel is an N-type TFT or a P-type TFT.

The present disclosure proposes a multiplex LCD driving circuit. By setting a new circuit structure, adjacent display pixels of the same color are opposite in polarity in the same row of subpixels. In this way, capacitance couplings between the data lines and the common electrodes are balanced off each other, which resolves the display picture abnormality caused by the coupling capacitance between the data line and the common electrode in the LTPS-LCD product.

### BRIEF DESCRIPTION OF THE DRAWINGS

The accompanying drawings described herein are used to provide further comprehension of the present disclosure, and is a part of the present application. Schematic embodiments of the present disclosure and the description thereof are used to illustrate the present disclosure, but do not constitute any improper limit to the present disclosure. In the accompanying drawings:

FIG. 1 illustrates a layout of using demultiplexers to drive subpixels of the related art.

FIG. 2 illustrates polarities of subpixels operated under a column inversion of the related art.

FIG. 3 illustrates a reloading image of the related art.

FIG. 4 illustrates a layout of using demultiplexers to drive subpixels according to an embodiment of the present disclosure.

FIG. 5 illustrates polarities of subpixels operated under a column inversion according to an embodiment of the present disclosure.

FIG. 6 illustrates a reloading image according to an embodiment of the present disclosure.

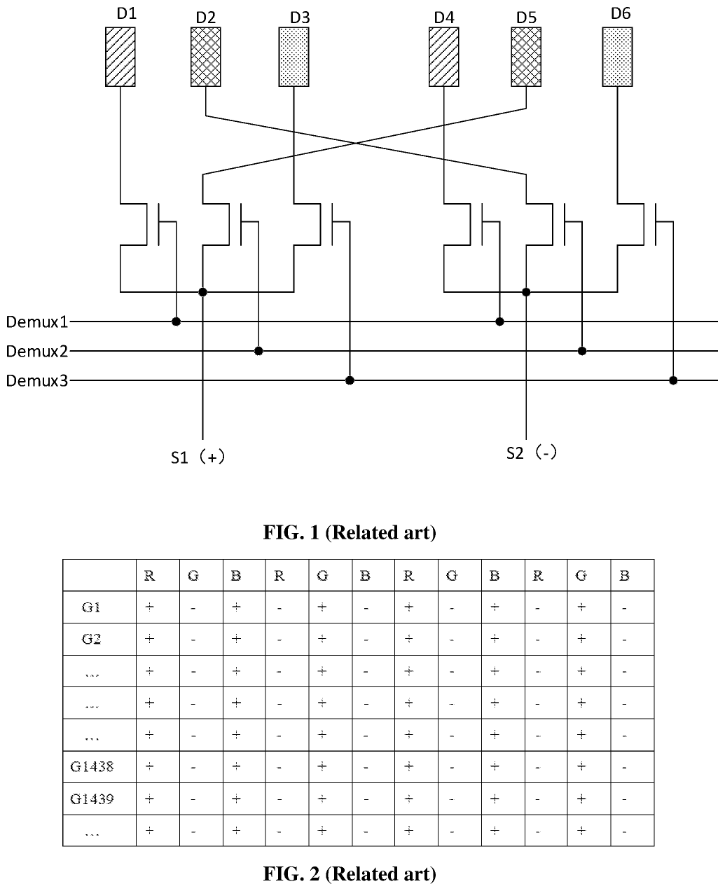

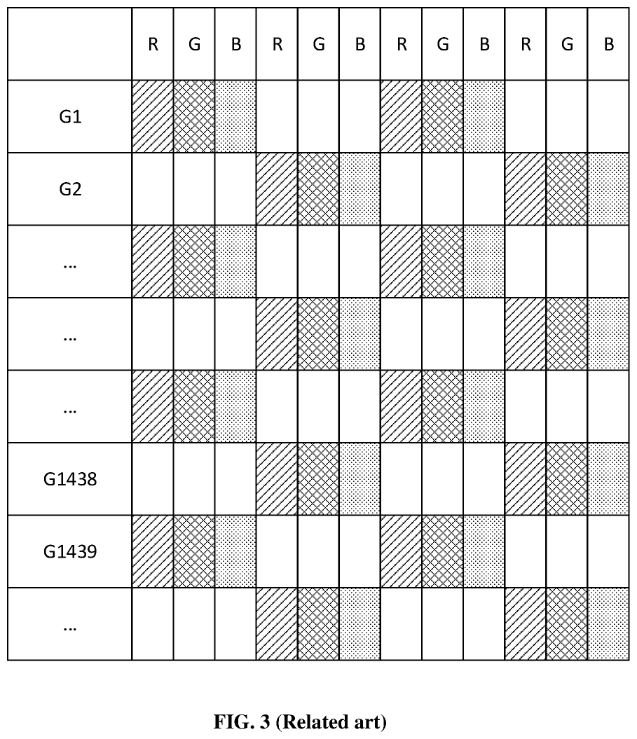

### DETAILED DESCRIPTION OF THE EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. In addition, the term “first”, “second” are for illustrative purposes only and are not to be construed as indicating or imposing a relative importance or implicitly indicating the number of technical features indicated.

In the description of this specification, the description of the terms “one embodiment”, “some embodiments”, “examples”, “specific examples”, or “some examples”, and the like, means to refer to the specific feature, structure, material or characteristic described in connection with the embodiments or examples being included in at least one embodiment or example of the present disclosure. In the present specification, the term of the above schematic representation is not necessary for the same embodiment or example. Furthermore, the specific feature, structure, material, or characteristic described may be in combination in a suitable manner in any one or more of the embodiments or examples. In addition, it will be apparent to those skilled in the art that different embodiments or examples described in this specification, as well as features of different embodiments or examples, may be combined without contradictory circumstances.

The present disclosure proposes a multiplexing liquid crystal display (LCD) driving circuit. The multiplexing LCD driving circuit includes a plurality of driving units. The plurality of driving units are configured to drive the LCD panel to display images.

Each of the driving units includes a plurality of multiplexing modules, a plurality of vertical data lines which are in parallel and arranged sequentially, two or more scanning lines which are in parallel and thus arranged in parallel, and subpixels 10 arranged in an area where the plurality of data lines and the plurality of scanning lines are interwoven.

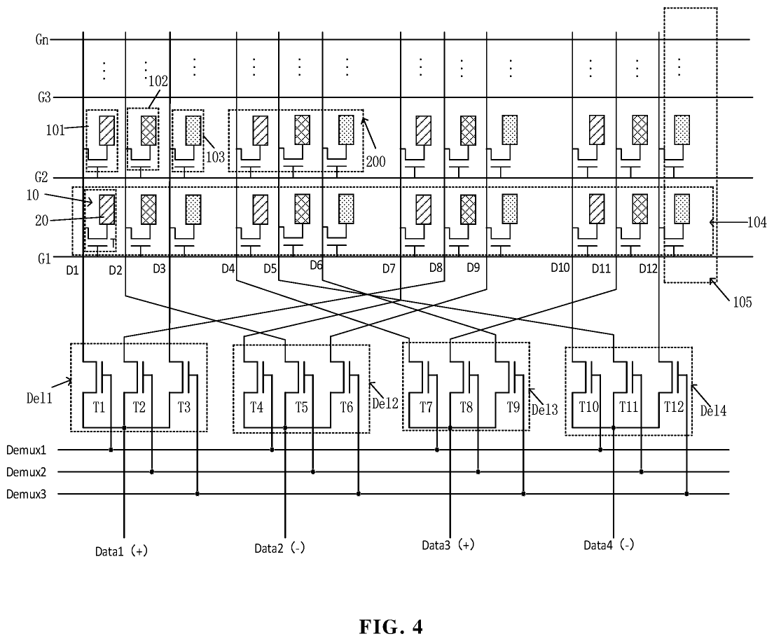

As FIG. 4 illustrates, the driving unit includes 12 data lines D1-D12, scanning lines G1-G (2n), and four multiplexing modules Del1-Del4 where n is a positive integer. The multiplexing module includes a first multiplexing module Del1, a second multiplexing module Del2, a third multiplexing module Del3, and a fourth multiplexing module Del4. Each of the multiplexing modules includes three thin film transistors (TFT). A gate of each of the TFTs is electrically connected to a first branch controlling signal, a second branch controlling signal, and a third branch controlling signal. A source of each of the TFTs is electrically connected to the same data signal. A drain of each of the TFTs is electrically connected to the data line.

The first multiplexing module Del1 includes a first TFT T1, a second TFT T2, and a third TFT T3.

A gate of the first TFT T1 is electrically connected to the first branch controlling signal Demux1. A source of the first TFT T1 is electrically connected to the first data signal Data1. A drain of the first TFT T1 is electrically connected to the first data line D1. The first TFT T1 is an N-type TFT or a P-type TFT.

A gate of the second TFT T2 is electrically connected to the second branch controlling signal Demux2. A source of the second TFT T2 is electrically connected to the first data signal Data1. A drain of the second TFT T2 is electrically connected to the eighth data line D8. The second TFT T2 is an N-type TFT or a P-type TFT.

A gate of the third TFT T3 is electrically connected to the third branch controlling signal Demux3. A source of the third TFT T3 is electrically connected to the first data signal Data1. A drain of the third TFT T3 is electrically connected to the third data line D3. The third TFT T3 is an N-type TFT or a P-type TFT.

The second multiplexing module Del2 includes a fourth TFT T4, a fifth TFT T5, and a sixth TFT T6.

A gate of the fourth TFT T4 is electrically connected to the first branch controlling signal Demux1. A source of the fourth TFT T4 is electrically connected to the second data signal Data2. A drain of the fourth TFT T4 is electrically connected to the second data line D7. The fourth TFT T4 is an N-type TFT or a P-type TFT.

A gate of the fifth TFT T5 is electrically connected to the second branch controlling signal Demux2. A source of the fifth TFT T5 is electrically connected to the second data signal Data2. A drain of the fifth TFT T5 is electrically connected to the third data line D2. The fifth TFT T5 is an N-type TFT or a P-type TFT.

A gate of the sixth TFT T6 is electrically connected to the third branch controlling signal Demux3. A source of the sixth TFT T6 is electrically connected to the second data signal Data2. A drain of the sixth TFT T6 is electrically connected to the fifth data line D9. The sixth TFT T6 is an N-type TFT or a P-type TFT.

The third multiplexing module Del3 includes a seventh TFT T7, an eighth TFT T8, and a ninth TFT T9.

A gate of the seventh TFT T7 is electrically connected to the first branch controlling signal Demux1. A source of the seventh TFT T7 is electrically connected to the third data signal Data3. A drain of the seventh TFT T7 is electrically connected to the seventh data line D4. The seventh TFT T7 is an N-type TFT or a P-type TFT.

A gate of the eighth TFT T8 is electrically connected to the second branch controlling signal Demux2. A source of the eighth TFT T8 is electrically connected to the third data signal Data3. A drain of the eighth TFT T8 is electrically connected to the ninth data line D11. The eighth TFT T8 is an N-type TFT or a P-type TFT.

A gate of the ninth TFT T9 is electrically connected to the third branch controlling signal Demux3. A source of the ninth TFT T9 is electrically connected to the third data signal Data3. A drain of the ninth TFT T9 is electrically connected to the twelfth data line D6. The ninth TFT T9 is an N-type TFT or a P-type TFT.

The fourth multiplexing module Del4 includes a tenth TFT T10, an eleventh TFT T11, and a twelfth TFT T12.

A gate of the tenth TFT T10 is electrically connected to the first branch controlling signal Demux1. A source of the tenth TFT T10 is electrically connected to the fourth data signal Data4. A drain of the tenth TFT T10 is electrically connected to the eighth data line D10. The ninth TFT T9 is an N-type TFT or a P-type TFT.

A gate of the eleventh TFT T11 is electrically connected to the second branch controlling signal Demux2. A source of the eleventh TFT T11 is electrically connected to the fourth data signal Data4. A drain of the eleventh TFT T11 is electrically connected to the tenth data line D5. The eleventh TFT T11 is an N-type TFT or a P-type TFT.

A gate of the twelfth TFT T12 is electrically connected to the third branch controlling signal Demux3. A source of the twelfth TFT T12 is electrically connected to the fourth data signal Data4. A drain of the twelfth TFT T12 is electrically connected to the eleventh data line D12. The twelfth TFT T12 is an N-type TFT or a P-type TFT.

The electrical property of the first data signal Data1 is the same as the electrical property of the third data signal Data3. The electrical property of the second data signal Data2 is the same as the electrical property of the fourth data signal Data4. The electrical property of the first data signal Data1 is different from the electrical property of the second data signal Data2.

A first data signal Data1 is a positive polarity, and a second data signal Data2 is a negative polarity in another embodiment, so half of the data lines are applied with positive polarity voltage and half of the data line are applied with negative polarity voltage. Couplings between the data lines and the common electrodes are balanced off each other, solving abnormality of image display which is caused by coupling capacitances between data lines and common electrodes in the LTPS-LCD products.

Each subpixel 10 includes a TFT T and a pixel electrode 20. A gate of the TFT T is electrically connected to a scanning line corresponding to the subpixel 10 in the row. A source of the TFT T is electrically connected to a data line corresponding to the subpixel 10 in the column. A drain of the TFT T is electrically connected to the pixel electrode 20. The TFT T for the subpixel 10 is an N-type TFT or a P-type TFT.

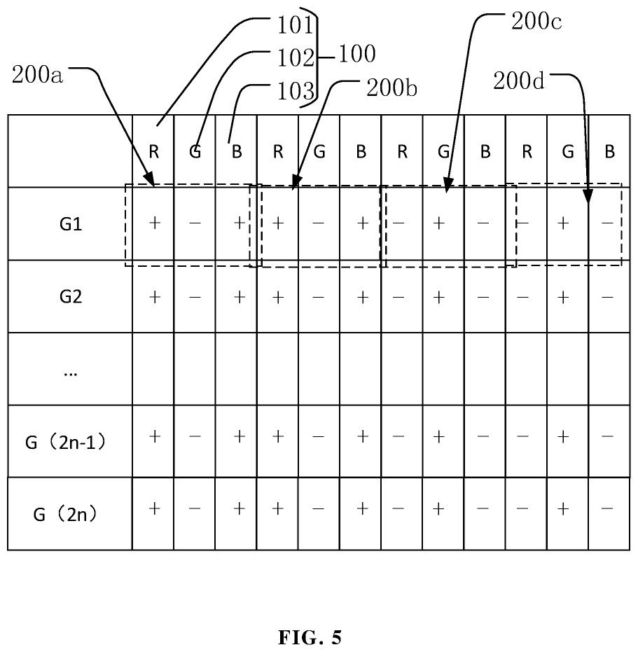

As FIG. 5 illustrates, the polarity of the subpixels 10 in the first to third columns are positive, negative, and positive in the present disclosure. Besides, the polarity of the subpixels 10 in the fourth to sixth columns are positive, negative, and positive. The polarity of the subpixels 10 in the seventh to ninth columns are negative, positive, and negative. The polarity of the subpixels 10 in the tenth to twelfth columns are negative, positive, and negative.

The subpixel 10 includes a subpixel 104 in a row and a subpixel 105 in a row. The subpixel 103 includes a plurality of red subpixels 101, a plurality of green subpixels 102, and a plurality of blue subpixels 103. The red subpixel 101, the green subpixel 102, the blue subpixel 103 form a plurality of display pixels. The subpixels 104, the red subpixel 101, the green subpixel 102, and the blue subpixel 103 in each row are alternately arranged.

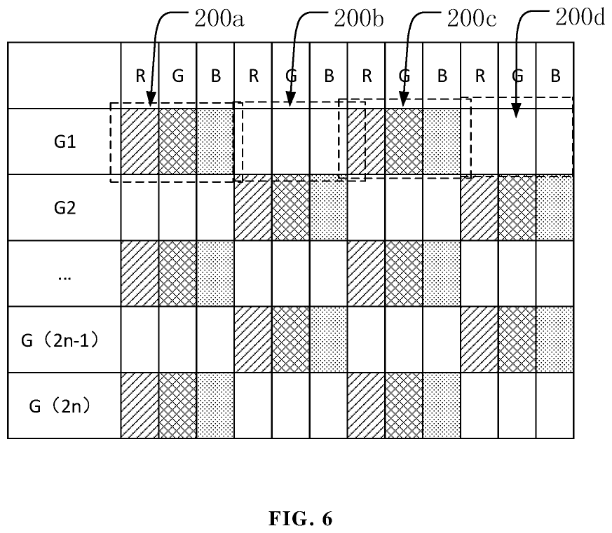

As FIG. 6 illustrates, each of the display pixels 200 includes a red subpixel 101, a green subpixel 102, and a blue subpixel 103 in the subpixel 104 in each row. The red subpixel 101, the green subpixel 102, and the blue subpixel 103 are sequentially arranged in each of the display pixels 200. The display pixel 200 may emit light or darken. The display pixel 200a of a color is different from the display pixel 200b of a color, as illustrated in FIG. 6.

Please refer to FIG. 5. The electrical property of a display pixel is opposite to the electrical property of a display pixel adjacent the former display pixel of the same color on display in the subpixels 104 on the same row. For example, in terms of the subpixel 104 in the same row, the display pixels 200a and 200c show the same color but both electrically opposite. Similarly, the display pixels 200b and 200d show the same color but both electrically opposite. The electrical property of the subpixel 105, especially the display pixel, is the same as the electrical property of a neighboring display pixel of the same color in the same column.

In the subpixel 104 in each row, the display pixel 200 of the same color may offset electricity of each other. Coupling between the data line and the common electrode offsets each other, which offsets coupling between data lines and common electrodes in the LTPS-LCD products between the data line and the common electrode. The coupling may causes abnormality of image display.

Above are embodiments of the present disclosure, which does not limit the scope of the present disclosure. Any modifications, equivalent replacements or improvements within the spirit and principles of the embodiment described above should be covered by the protected scope of the invention.

What is claimed is:

1. A multiplexing liquid crystal display (LCD) driving circuit, comprising a plurality of driving units; each of the plurality of driving units comprising a plurality of multiplexing modules, a plurality of vertical data lines which are in parallel and arranged sequentially, two or more scanning lines which are in parallel and thus arranged in parallel, and subpixels arranged in an area surrounded by the plurality of data lines and the plurality of scanning lines;
wherein each of the subpixels is correspondingly connected to the scanning line and the data line, respectively; the subpixel comprises the subpixels in a plurality rows and a plurality of column subpixels and the subpixels in a plurality columns;
each of the subpixel in the row comprises a plurality of red subpixels, a plurality of green subpixels, and a plurality of blue subpixels; the red subpixel, the green subpixel, and the blue subpixel forming a plurality of display pixels; one of the red subpixel, one of the green subpixel, and one of the blue subpixel forming each of a plurality of display pixels;
the electrical property of a display pixel being opposite to the electrical property of a display pixel adjacent the former display pixel of the same color on display in the subpixels in the same row.

2. The multiplexing LCD driving circuit of claim 1, wherein the driving unit comprises 12 data lines (D1-D12) and four multiplexing modules (Del1-Del4);
each of the multiplexing modules comprises three thin film transistors (TFT); a gate of each of the TFTs is electrically connected to a first branch controlling signal (Demux1), a second branch controlling signal (Demux2), and a third branch controlling signal (Demux3); a source of each of the TFTs is electrically connected to the same data signal; a drain of each of the TFTs is electrically connected to the data line.

3. The multiplexing LCD driving circuit of claim 2, wherein the multiplexing module comprises a first multiplexing module (Del1), a second multiplexing module (Del2), a third multiplexing module (Del3), and a fourth multiplexing module (Del4);
the first multiplexing module (Del1) comprises:
a first TFT (T1); a gate of the first TFT (T1) is electrically connected to the first branch controlling signal (Demux1); a source of the first TFT (T1) is electrically connected to the first data signal (Data1); a drain of the first TFT (T1) is electrically connected to the first data line (D1);
a second TFT (T2); a gate of the second TFT (T2) is electrically connected to the second branch controlling signal (Demux2); a source of the second TFT (T2) is electrically connected to the first data signal (Data1); a drain of the second TFT (T2) is electrically connected to the eighth data line (D8); and
a third TFT (T3); a gate of the third TFT (T3) is electrically connected to the third branch controlling signal (Demux3); a source of the third TFT (T3) is electrically connected to the first data signal (Data1); a drain of the third TFT (T3) is electrically connected to the third data line (D3);
the second multiplexing module (Del2) comprises:
a fourth TFT (T4); a gate of the fourth TFT (T4) is electrically connected to the first branch controlling signal (Demux1); a source of the fourth TFT (T4) is electrically connected to the second data signal (Data2); a drain of the fourth TFT (T4) is electrically connected to the second data line (D7);
a fifth TFT (T5); a gate of the fifth TFT (T5) is electrically connected to the second branch controlling signal (Demux2); a source of the fifth TFT (T5) is electrically connected to the second data signal (Data2); a drain of the fifth TFT (T5) is electrically connected to the third data line (D2); and
a sixth TFT (T6); a gate of the sixth TFT (T6) is electrically connected to the third branch controlling signal (Demux3); a source of the sixth TFT (T6) is electrically connected to the second data signal (Data2); a drain of the sixth TFT (T6) is electrically connected to the fifth data line (D9);
the third multiplexing module (Del3) comprises:
a seventh TFT (T7); a gate of the seventh TFT (T7) is electrically connected to the first branch controlling signal (Demux1); a source of the seventh TFT (T7) is electrically connected to the third data signal (Data3); a drain of the seventh TFT (T7) is electrically connected to the seventh data line (D4);
an eighth TFT (T8); a gate of the eighth TFT (T8) is electrically connected to the second branch controlling signal (Demux2); a source of the eighth TFT (T8) is electrically connected to the third data signal Data3; a drain of the eighth TFT (T8) is electrically connected to the ninth data line (D11); and
a ninth TFT (T9); a gate of the ninth TFT (T9) is electrically connected to the third branch controlling signal (Demux3); a source of the ninth TFT (T9) is electrically connected to the third data signal (Data3); a drain of the ninth TFT (T9) is electrically connected to the twelfth data line (D6);
the fourth multiplexing module (Del4) comprises:
a tenth TFT (T10); a gate of the tenth TFT (T10) is electrically connected to the first branch controlling signal (Demux1); a source of the tenth TFT (T10) is electrically connected to the fourth data signal (Data4); a drain of the tenth TFT (T10) is electrically connected to the eighth data line (D10);
an eleventh TFT (T11); a gate of the eleventh TFT (T11) is electrically connected to the second branch controlling signal (Demux2); a source of the eleventh TFT (T11) is electrically connected to the fourth data signal (Data4); a drain of the eleventh TFT (T11) is electrically connected to the tenth data line (D5); and
a twelfth TFT (T12); a gate of the twelfth TFT (T12) is electrically connected to the third branch controlling signal (Demux3); a source of the twelfth TFT (T12) is electrically connected to the fourth data signal (Data4); a drain of the twelfth TFT (T12) is electrically connected to the eleventh data line (D12);

4. The multiplexing LCD driving circuit of claim 3, wherein the first multiplexing module (Del1), the second multiplexing module (Del2), the third multiplexing module (Del3), and the fourth multiplexing module (Del4) are all N-type TFTs or P-type TFTs.

5. The multiplexing LCD driving circuit of claim 3, wherein the electrical property of the first data signal (Data1) is the same as the electrical property of the third data signal (Data3);
the electrical property of the second data signal (Data2) is the same as the electrical property of the fourth data signal (Data4);
the electrical property of the first data signal (Data1) is different from the electrical property of the second data signal (Data2).

6. The multiplexing LCD driving circuit of claim 1, wherein the electrical properties of the subpixels in the same column are the same;
the electrical property of the display pixel in the same column is the same as the electrical property of a neighboring display pixels of the same color in the same column.

7. The multiplexing LCD driving circuit of claim 1, wherein the subpixels, the red subpixel, the green subpixel, and the blue subpixel in each row are alternately arranged.

8. The multiplexing LCD driving circuit of claim 1, wherein each subpixel (10) includes a TFT (T) and a pixel electrode; a gate of the TFT (T) is electrically connected to a scanning line corresponding to the subpixel in the row; a source of the TFT (T) is electrically connected to a data line corresponding to the subpixel (10) in the column; a drain of the TFT (T) is electrically connected to the pixel electrode (20).

9. The multiplexing LCD driving circuit of claim 2, wherein the subpixel in the column comprises a 12 columns of subpixels; the polarity of the subpixels (10) in the first to third columns are positive, negative, and positive; the polarity of the subpixels (10) in the fourth to sixth columns are positive, negative, and positive; the polarity of the subpixels (10) in the seventh to ninth columns are negative, positive, and negative; the polarity of the subpixels (10) in the tenth to twelfth columns are negative, positive, and negative.

10. The multiplexing LCD driving circuit of claim 8, wherein the TFT of the subpixel is an N-type TFT or a P-type TFT.
